(19) United States
(12) Patent Application Publication
(10) Pub. No.: US 2026/0248318 A1
(43) Pub. Date: Aug. 27, 2026

(54) BREWING MACHINE WITH SUGAR DISSOLVING FUNCTION

(71) Applicant: Tsamm Kuen (Zhangzhou) Enterprise Co., Ltd., Zhangzhou City (CN)

(72) Inventors: Yangtai HE, Zhangzhou City (CN); Guozuan ZENG, Zhangzhou City (CN); Xiaorong ZHANG, Zhangzhou City (CN); Zhiyong LIN, Zhangzhou City (CN)

(21) Appl. No.: 19/446,437

(22) Filed: Jan. 12, 2026

(30) Foreign Application Priority Data
Feb. 21, 2025 (CN) 202510198845.4
May 13, 2025 (CN) 202510610733.5

(51) Int. Cl. A47J 31/40; A47J 31/06; A47J 31/54

(52) U.S. Cl. CPC A47J 31/404; A47J 31/0615; A47J 31/54

(57) ABSTRACT

The present invention provides a brewing machine with a sugar dissolving function, including a brewing chamber, a water guiding cavity, and a sugar dissolving chamber. An outlet of the brewing chamber is connected to the water guiding cavity. The water guiding cavity is arranged on a periphery of the sugar dissolving chamber. A wall of the sugar dissolving chamber is provided with a plurality of circumferentially distributed through holes. The through holes are in communication with the water guiding cavity. A bottom of the sugar dissolving chamber is provided with a water outlet. The water outlet is provided with a switch valve. The brewing machine integrates the brewing and sugar dissolving functions, and enables rapid and thorough sugar dissolution.

### CROSS-REFERENCE TO RELATED APPLICATIONS

This application claims priority to Chinese Patent Application 202510610733.5, filed on 13 May 2025, and Chinese Patent Application 202510198845.4, filed on 21 February 2025. Chinese Patent Application 202510610733.5 and Chinese Patent Application 202510198845.4 are incorporated herein by reference.

### TECHNICAL FIELD

The present invention relates to the field of electrical equipment, and in particular to a brewing machine with a sugar dissolving function.

### BACKGROUND

Conventional beverage (especially tea) preparation methods typically involve placing tea leaves into a drinking cup or brewing pot, and then pouring boiling water to steep for a certain period. However, with the improvement of living standards and the acceleration of life pace, various electric tea makers, iced tea and coffee machines, water purifiers, and other drinking water devices have become common in households, greatly enriching people's lives. Currently, existing devices typically only have a brewing function and do not have a sugar dissolving function. To meet the market demand, it is necessary to design a brewing machine capable of dissolving sugar at the same time.

### SUMMARY

To solve the above problems, the present invention provides a brewing machine with a sugar dissolving function.

To achieve the above objective, the present invention provides the following the technical solution:

A brewing machine with a sugar dissolving function includes a brewing chamber, a water guiding cavity, and a sugar dissolving chamber. An outlet of the brewing chamber is connected to the water guiding cavity. The water guiding cavity is arranged on a periphery of the sugar dissolving chamber. A wall of the sugar dissolving chamber is provided with a plurality of circumferentially distributed through holes. The through holes are in communication with the water guiding cavity. A bottom of the sugar dissolving chamber is provided with a water outlet. The water outlet is provided with a switch valve.

Further, the plurality of circumferentially distributed through holes provided in the wall of the sugar dissolving chamber include a plurality of water passing holes and a plurality of steam holes, and a height of the steam holes is greater than a height of the water passing holes.

Further, the brewing machine includes a cup basket part. The cup basket part includes a cup basket and a water guiding base, and the brewing chamber and the sugar dissolving chamber are formed on the cup basket. The water guiding base is sleeved on a peripheral side of the cup basket. The water guiding base and an outer wall of the cup basket jointly form the water guiding cavity. The plurality of water passing holes and the plurality of steam holes are provided in the outer wall of the cup basket.

Further, the wall of the sugar dissolving chamber is further provided with air passing holes in communication with the brewing chamber. A height of the air passing holes is greater than a height of the water guiding cavity.

Further, the brewing chamber is located on one side of the sugar dissolving chamber and above the water guiding cavity, and the wall of the sugar dissolving chamber is not provided with the water passing holes at a side corresponding to the outlet of the brewing chamber.

Further, the sugar dissolving chamber is a tapered chamber with a wide top and a narrow bottom.

Further, an angle between a tapered side wall of the sugar dissolving chamber and a vertical central axis is less than or equal to 45°.

Further, a filter mesh is provided at a top of the water outlet, and a height of the filter mesh is less than the height of the water passing holes.

Further, a height difference between the water passing holes and the filter mesh is greater than 5 mm. A height difference between the steam holes and the water passing holes is greater than 10 mm.

Further, the switch valve includes a push rod, a silicone ring, and an elastic member. The push rod runs through the water outlet of the sugar dissolving chamber with a gap. The silicone ring is fixed at a first end of the push rod extending into the sugar dissolving chamber, and the elastic member applies an elastic force away from the sugar dissolving chamber to the push rod, so that the silicone ring on the push rod is pressed to seal the water outlet of the sugar dissolving chamber.

Further, the brewing machine further includes a housing, a water tank, and a heating assembly. The water tank, the heating assembly, and the cup basket part are all arranged at the housing, and an outlet of the water tank is connected to the heating assembly. An output end of the heating assembly is connected to the brewing chamber to output heated water to the brewing chamber. A clearance space for placing a container is formed on one side of the housing, and the water outlet of the sugar dissolving chamber is located at a top of the clearance space.

Further, the outlet of the brewing chamber is provided with a removable filtration mesh.

Further, the brewing machine includes a cup basket part. The cup basket part includes a cup basket and a water guiding base, and the brewing chamber and the sugar dissolving chamber are formed on the cup basket. A periphery of the cup basket is integrally connected with an annular wall, thereby forming an annular cavity with a bottom opening. The water guiding base is sealed and fixedly covers the bottom opening of the annular cavity, thereby jointly forming the water guiding cavity. A plurality of through holes are provided in a side wall of the cup basket.

The technical solution provided by the present invention has the following beneficial effects:

1. According to the brewing machine with a sugar dissolving function provided in this application, before use, a material to be brewed (such as tea leaves or coffee) is put into the brewing chamber, and sugar is put into the sugar dissolving chamber. During use, the heated water is poured into the brewing chamber for brewing to obtain a brewed solution, which then flows into the water guiding cavity. The brewed solution in the water guiding cavity enters the sugar dissolving chamber through the plurality of circumferentially distributed through holes, thereby dissolving the sugar in the sugar dissolving chamber. Finally, the user can control the switch valve to output the sugar-containing beverage.

2. The plurality of circumferentially distributed through holes in the wall of the sugar dissolving chamber include the plurality of water passing holes and the plurality of steam holes, and the height of the steam holes is greater than the height of the water passing holes. The brewed solution in the water guiding cavity enters the sugar dissolving chamber through the plurality of circumferentially distributed water passing holes, starting to dissolve the sugar from the bottom. This facilitates complete dissolution of the sugar in the sugar dissolving chamber and prevents situations such as sugar residue remaining in the sugar dissolving chamber or undissolved sugar blocking the bottom of the sugar dissolving chamber. Moreover, in the initial stage, steam of the brewed solution enters the sugar dissolving chamber through the steam holes above to preheat the sugar on the top. As the brewed solution continues to flow into the water guiding cavity, the liquid level in the water guiding cavity rises, and the brewed solution also flows into the sugar dissolving chamber through the steam holes to dissolve the sugar on the top at the same time. Thus, the sugar can be dissolved rapidly and thoroughly, with high efficiency, thereby reducing the waiting time of the user.

### BRIEF DESCRIPTION OF DRAWINGS

FIG. 1 is a side view of a brewing machine with a sugar dissolving function according to Embodiment I;

FIG. 2 is a schematic structural view of the brewing machine with a sugar dissolving function with a cover plate opened according to Embodiment I;

FIG. 3 is a schematic structural exploded view of the brewing machine with a sugar dissolving function according to Embodiment I;

FIG. 4 is a sectional view of the brewing machine with a sugar dissolving function according to Embodiment I;

FIG. 5 is a schematic three-dimensional view of a cup basket part of the brewing machine with a sugar dissolving function according to Embodiment I;

FIG. 6 is a sectional view of the cup basket part of the brewing machine with a sugar dissolving function according to Embodiment I;

FIG. 7 is a schematic structural exploded view of the cup basket part of the brewing machine with a sugar dissolving function according to Embodiment III;

FIG. 8 is a vertical sectional view of the cup basket part of the brewing machine with a sugar dissolving function according to Embodiment III; and

FIG. 9 is a horizontal sectional view of the cup basket part of the brewing machine with a sugar dissolving function according to Embodiment III.

### DESCRIPTION OF EMBODIMENTS

### Embodiment I

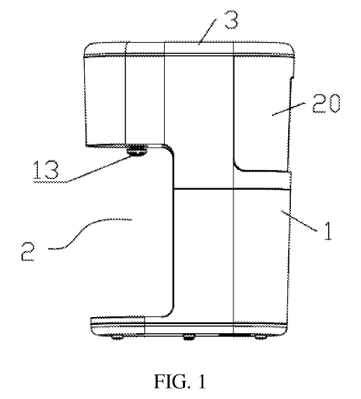

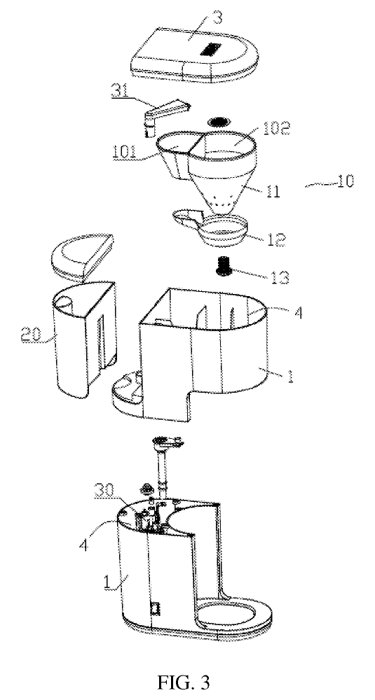

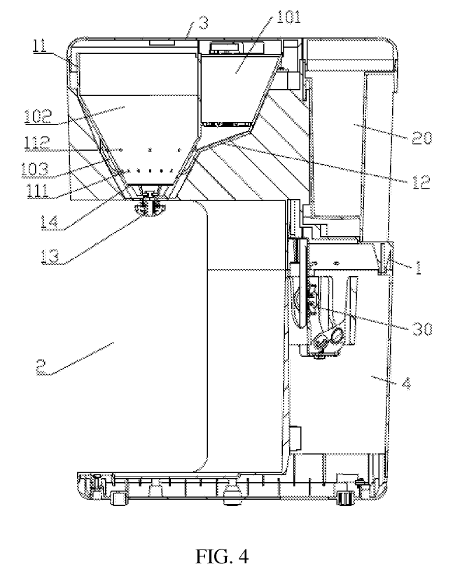

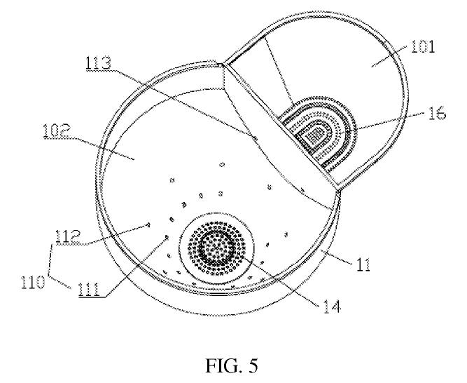

Referring to FIG. 1 to FIG. 6, this embodiment provides a brewing machine with a sugar dissolving function. The brewing machine is specifically a tea brewing machine. The brewing machine includes a brewing chamber 101, a water guiding cavity 103, and a sugar dissolving chamber 102. An outlet 1011 of the brewing chamber 101 is connected to the water guiding cavity 103. The water guiding cavity 103 is arranged on a periphery of the sugar dissolving chamber 102. A wall 1021 of the sugar dissolving chamber 102 is provided with a plurality of circumferentially distributed through holes 110. The plurality of through holes 110 include a plurality of water passing holes 111 and a plurality of steam holes 112. In this embodiment, the plurality of water passing holes 111 are distributed circumferentially in a circle, and the plurality of steam holes 112 are also distributed circumferentially in a circle. The water passing holes 111 and the steam holes 112 are in communication with the water guiding cavity 103, and a height of the steam holes 112 is greater than a height of the water passing holes 111. A bottom of the sugar dissolving chamber 102 is provided with a water outlet 15. The water outlet 15 is provided with a switch valve 13.

Before use, tea leaves are put into the brewing chamber 101, and sugar is put into the sugar dissolving chamber 102. During use, heated water is poured into the brewing chamber 101 for brewing. The brewed tea then flows into the water guiding cavity 103, and the tea in the water guiding cavity 103 enters the sugar dissolving chamber 102 through the plurality of circumferentially distributed water passing holes 111, starting to dissolve the sugar from the bottom. This facilitates complete dissolution of the sugar in the sugar dissolving chamber and prevents situations such as sugar residue remaining in the sugar dissolving chamber or undissolved sugar blocking the bottom of the sugar dissolving chamber. Moreover, in the initial stage, as there is little tea in the water guiding cavity 103, steam of the tea enters the sugar dissolving chamber 102 through the steam holes 112 above to preheat the sugar on the top, effectively raising the temperature of the sugar on the top. As the tea continues to flow into the water guiding cavity 103, the liquid level in the water guiding cavity 103 rises, and the tea also flows into the sugar dissolving chamber 102 through the steam holes 112 to dissolve the sugar on the top at the same time. Thus, the sugar can be dissolved rapidly and thoroughly, with high efficiency, thereby reducing the waiting time of the user. Finally, the user can control the switch valve 13 to output the sugar-containing tea.

The brewing machine includes a cup basket part 10. The cup basket part 10 includes a cup basket 11 and a water guiding base 12. The brewing chamber 101 and the sugar dissolving chamber 102 are formed on the cup basket 11. In this embodiment, the cup basket 11 is integrally formed to obtain two chambers, which are the brewing chamber 101 and the sugar dissolving chamber 102, respectively. The water guiding base 12 is sleeved on a peripheral side of a lower part of the cup basket 11. The water guiding base 12 and an outer wall of the cup basket 11 jointly form the water guiding cavity 103. The plurality of water passing holes 111 and the plurality of steam holes 112 are formed in the outer wall of the cup basket 11. With this arrangement, the layout of three chambers is achieved through two assembly structures, resulting in a simple structure. In other embodiments, the cup basket 11 and the water guiding base 12 may also be fixedly connected.

Further, in this embodiment, the brewing chamber 101 is located on one side of the sugar dissolving chamber 102 and above the water guiding cavity 103. The outlet 1011 of the brewing chamber 101 is located at its bottom. The tea in the brewing chamber 101 flows into the water guiding cavity 103 through the outlet 1011 at the bottom by gravity. Moreover, to prevent the tea outputted from the brewing chamber 101 from directly flowing into the sugar dissolving chamber 102, in this embodiment, the wall 1021 of the sugar dissolving chamber 102 is not provided with the water passing holes 111 at a side corresponding to the outlet 1011 of the brewing chamber 101. That is, after the tea outputted from the brewing chamber 101 flows into the water guiding cavity 103, since this side cannot directly communicate with the sugar dissolving chamber 102, the tea is forced to be diverted to other positions in the water guiding cavity 103 and then flows into the sugar dissolving chamber 102 through the water passing holes 111 at other positions. In this way, the tea flowing into the sugar dissolving chamber 102 is more evenly distributed.

In this embodiment, although the side facing the outlet 1011 of the brewing chamber 101 is not provided with the water passing holes 111, the tea can still flow into the sugar dissolving chamber through the water passing holes 111 in other directions, so that the sugar on the bottom can be fully contacted, thereby achieving rapid and thorough sugar dissolution.

In this embodiment, the outlet 1011 of the brewing chamber 101 is provided with a filtration mesh 16 for removing tea leaves or other materials to be brewed. It can be understood that the filtration mesh 16 may be made of a rigid material with filtration holes or a flexible material such as a gauze.

Further, in this embodiment, the plurality of water passing holes 111 are provided at the same height such that the tea can flow into the sugar dissolving chamber 102 at the same time. Likewise, the plurality of steam holes 112 are also provided at the same height, ensuring that the tea also flows in through the plurality of steam holes 112 to dissolve the sugar on the top when the liquid level is high. Thus, sugar dissolution consistency is good.

Specifically, due to the large height of the steam holes 112, in the initial stage, the tea outputted from the brewing chamber 101 does not directly enter the sugar dissolving chamber 102 through the steam holes 112. Therefore, there is no restriction on the position of the steam holes 112. For example, in this embodiment, the plurality of steam holes 112 are evenly distributed circumferentially along the wall 1021 of the sugar dissolving chamber 102. Moreover, the plurality of water passing holes 111 are also evenly distributed in positions other than the side corresponding to the outlet 1011 of the brewing chamber 101, thereby ensuring uniform pouring of tea. Of course, in other embodiments, the heights of the plurality of water passing holes 111 may be different, or the heights of the plurality of steam holes 112 may also be different, etc.

Further, the water passing holes 111 are located at the very bottom of the water guiding cavity 103, and a bottom side wall 121 of the water guiding base 12 is inclined to ensure that tea does not remain.

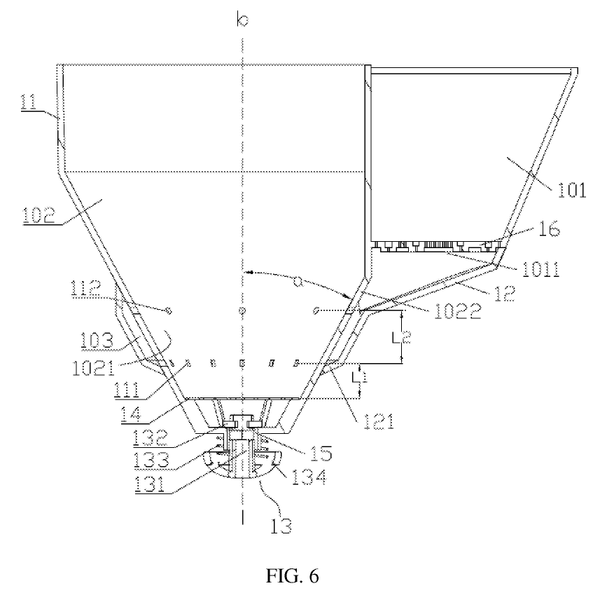

Further, in this embodiment, the sugar dissolving chamber 102 is a tapered chamber with a wide top and a narrow bottom, specifically a conical chamber with a wide top and a narrow bottom. The water outlet 15 is formed at a bottom tip of the sugar dissolving chamber 102, so that the liquid is not easily retained. Preferably, as shown in FIG. 6, an angle a between a tapered side wall 1022 of the sugar dissolving chamber 102 and a vertical central axis b is less than or equal to 45°, so that the space at the bottom of the sugar dissolving chamber 102 is relatively small, and under the condition of a fixed amount of water, the water pressure is relatively high, which is beneficial for output.

The water guiding cavity 103 is a circular ring-shaped cavity distributed on the periphery of the conical sugar dissolving chamber 102, which better guides the tea from all directions around the periphery into the sugar dissolving chamber 102.

Of course, in other embodiments, the structures of the sugar dissolving chamber 102 and/or the water guiding cavity 103 are not limited thereto. For example, the sugar dissolving chamber 102 may also be a triangular pyramidal chamber with a wide top and a narrow bottom, or a cylindrical chamber with a uniform diameter, etc. For example, the water guiding cavity 103 may also be a C-shaped cavity (i.e., not completely encircling the sugar dissolving chamber 102).

Further, a filter mesh 14 is provided at a top of the water outlet 15, and a height of the filter mesh 14 is less than the height of the water passing holes 111. The filter mesh 14 is configured to support sugar granules and filter out undissolved sugar granules. Preferably, as shown in FIG. 6, a height difference L1 between the water passing holes 111 and the filter mesh 14 is greater than 5 mm, and a height difference L2 between the steam holes 112 and the water passing holes 111 is greater than 10 mm, which means that the tea flows into the sugar pile at least from a certain height to better dissolve the sugar. This is more conducive to sugar dissolution. Of course, in other embodiments, the positional relationship among the water passing holes 111, the filter mesh 14, and the steam holes 112 is not limited thereto, as long as the water passing holes 111 are higher than the filter mesh 14 and the steam holes 112 are higher than the water passing holes 111. Alternatively, the filter mesh 14 may also be omitted.

Preferably, in this embodiment, the wall 1021 of the sugar dissolving chamber 102 is further provided with air passing holes 113 in communication with the brewing chamber 101. A height of the air passing holes 113 is greater than the height of the steam holes 112. The provision of the air passing holes 113 allows saturated steam in the brewing chamber 101 to flow into the sugar dissolving chamber 102 through the air passing holes 113 to preheat the sugar on the top in the sugar dissolving chamber 102, thereby fully utilizing the heat source and further improving the sugar dissolving efficiency.

Specifically, the brewing chamber 101 is a closed chamber to ensure the collection of steam. Further, the closeness of the brewing chamber 101 is formed by a cover plate 3 of a housing 1 described below covering an upper opening of the brewing chamber 101. Of course, in other embodiments, the air passing holes 113 may also be omitted.

Further, the switch valve 13 includes a push rod 131, a silicone ring 132, and an elastic member 133. The push rod 131 runs through the water outlet 15 of the sugar dissolving chamber 102 with a gap. The silicone ring 132 is fixed at a first end of the push rod 131 extending into the sugar dissolving chamber 102, and the elastic member 133 applies an elastic force away from the sugar dissolving chamber 102 to the push rod 131. Specifically, the elastic member 133 is a spring. A second end of the push rod 131 at the bottom is provided with an abutting head 134. The spring is sleeved on the push rod 131, and two ends of the spring abut between the cup basket 11 and the abutting head 134, so that the silicone ring 132 on the push rod 131 is pressed to seal the water outlet 15 of the sugar dissolving chamber 102. When the water output is required, it is simply required to press the container (teacup) against the second end of the push rod 131, causing the push rod 131 to move upward, thereby making the silicone ring 132 separated from the water outlet 15 of the sugar dissolving chamber 102. In this way, the water outlet 15 of the sugar dissolving chamber 102 can be opened, enabling the output of the sugar-dissolved tea. As a result, the structure is simple. Of course, in other embodiments, the structure of the switch valve 13 is not limited thereto and may also adopt other manual switch valves with handles for manual control or electric valves for electric control.

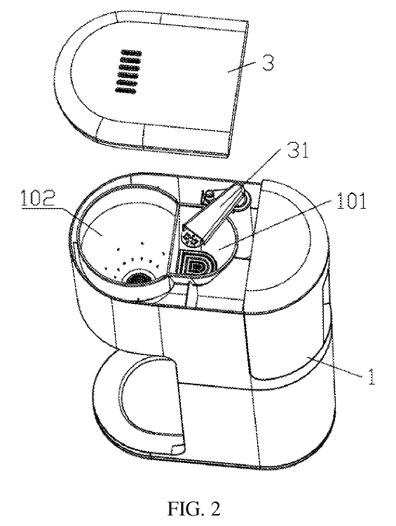

The brewing machine further includes a housing 1, a water tank 20, and a heating assembly 30. Specifically, the water tank 20, the heating assembly 30, and the cup basket part 10 are all arranged at the housing 1. In this embodiment, the housing 1 is provided with a mounting cavity 4. The heating assembly 30 and the cup basket part 10 are arranged inside the mounting cavity 4, and the water tank 20 is arranged on the outside of the housing 1, forming an integrated structure. Moreover, the housing 1 is provided with an openable cover plate 3, as shown in FIG. 2. By opening the cover plate 3, the cup basket part 10 is exposed, facilitating the addition of tea leaves to the brewing chamber 101 and sugar to the sugar dissolving chamber 102. After the cover plate 3 is closed, the brewing chamber 101 is closed at the same time.

The water tank 20 is configured to store cold water, and an outlet of the water tank 20 is connected to the heating assembly 30. An output end of the heating assembly 30 is connected to the brewing chamber 101. When in use, the cold water in the water tank 20 is outputted to the heating assembly 30, heated to a set temperature by the heating assembly 30, and then outputted by the heating assembly 30 to the brewing chamber 101 for brewing. Specifically, the output of water from the water tank 20 and the output from the heating assembly 30 to the brewing chamber 101 can both be achieved by controlling the operation of a water pump via a control system. For example, the housing 1 is provided with a water outlet tube 31, the water outlet tube 31 is located at the upper opening of the brewing chamber 101, and the heating assembly 30 outputs heated water to the brewing chamber 101 via the water outlet tube 31. The heating assembly 30 may be realized by using electric heating wires or similar technologies known in the art.

A clearance space 2 for placing a container is formed on one side of the housing 1, and the water outlet 15 of the sugar dissolving chamber 102 is located at a top of the clearance space 2. As shown in FIG. 1, the switch valve 13 is exposed in the clearance space 2 for operation. The clearance space 2 is configured to place the container to be filled (such as a teacup).

Of course, in other embodiments, the heating assembly 30 may also be directly arranged in the brewing chamber 101 to directly heat the water in the brewing chamber 101. Moreover, to better control the output of water in the brewing chamber 101, the outlet 1011 of the brewing chamber 101 may also be provided with a control valve structure. The housing 1 may also be implemented by other structures.

### Embodiment II

This embodiment provides a brewing machine with a sugar dissolving function. The brewing machine is a coffee brewing machine with a structure substantially the same as that provided in Embodiment I. The difference is that, in this embodiment, the outlet 1011 of the brewing chamber 101 is provided with a removable filter basket, and the filter basket includes a filtration mesh for removing used coffee grounds. Moreover, the removable design of the filter basket allows for easy removal of used coffee grounds. It can be understood that in other embodiments, the filter basket may also be used for removing tea leaves or other brewed materials.

### Embodiment III

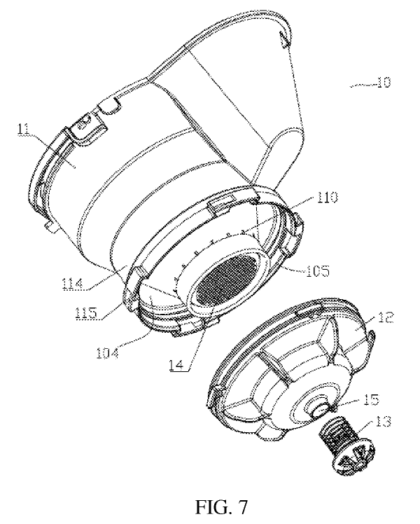

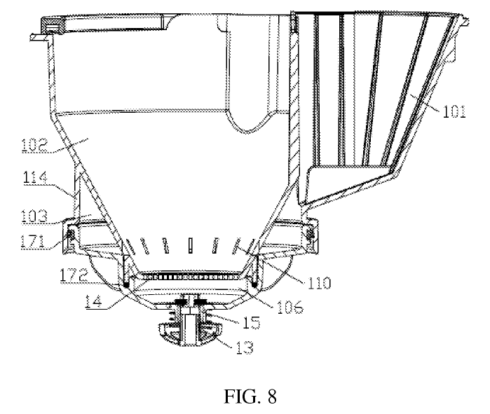

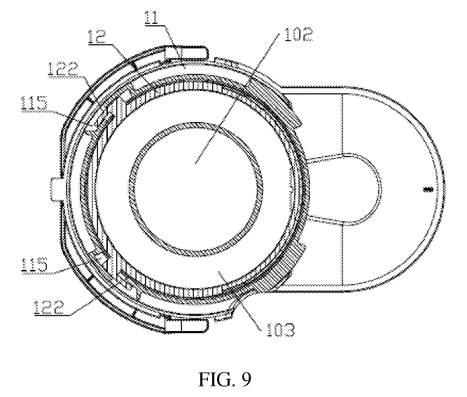

This embodiment provides a brewing machine with a sugar dissolving function with a structure substantially the same as that provided in Embodiment I. The difference lies in the structure of the cup basket part 10. Specifically, referring to FIG. 7 to FIG. 9, the brewing machine includes a cup basket part. The cup basket part 10 includes a cup basket 11 and a water guiding base 12. The brewing chamber 101 and the sugar dissolving chamber 102 are formed on the cup basket 11. A periphery of the cup basket 11 is integrally connected with an annular wall 114, thereby forming an annular cavity 104 with a bottom opening 105. The water guiding base 12 is sealed and fixedly covers the bottom opening 105 of the annular cavity 104, thereby jointly forming the water guiding cavity 103, i.e., the annular cavity 104 sealed by the water guiding base 12 forms the water guiding cavity 103. Likewise, a plurality of through holes 110 are provided in a side wall of the cup basket 11, specifically in the side wall forming the sugar dissolving chamber 102. An inner wall surface of the side wall forming the sugar dissolving chamber 102 is the wall 1021. In this way, the arrangement of the brewing chamber 101, the sugar dissolving chamber 102, and the water guiding cavity 103 can also be achieved.

Further, in this embodiment, after the water guiding base 12 and the cup basket 11 are assembled, the outer ring is sealed by an outer sealing ring 171, and the inner ring is sealed by an inner sealing ring 172. Moreover, the water guiding base and the cup basket may be fixed by a rotational snap-fit structure. The structure is as follows: the annular wall 114 is provided with a plurality of snap-fit slots 115, specifically "Z"-shaped snap-fit slots, and an outer edge of the water guiding base 12 is provided with snap-fit protrusions 122, specifically "L"-shaped snap-fit protrusions. The snap-fit protrusions 122 are aligned with the snap-fit slots 115 and then rotated to snap into the snap-fit slots, thereby achieving fixed connection, which is simple in structure and easy to operate. Of course, in other embodiments, the water guiding base 12 and the cup basket 11 may also be fixed by bolt fastening, adhesive bonding, or the like.

Specifically, in this embodiment, the plurality of through holes 110 are provided only in a single circle along the periphery of the wall 1021 of the sugar dissolving chamber 102. When the water level in the water guiding cavity 103 is lower than the through holes 110, steam first enters the sugar dissolving chamber 102 through the through holes 110 to preheat the sugar. As the water level in the water guiding cavity 103 rises, the brewed solution enters the sugar dissolving chamber 102 through the through holes 110 to dissolve the sugar, thereby also effectively dissolving the sugar. Of course, the plurality of through holes 110 in this embodiment may also be designed as the plurality of water passing holes 111 and the plurality of steam holes 112 in Embodiment I.

Furthermore, in this embodiment, the filter mesh 14 provided at the top of the water outlet 15 is integrally formed with the cup basket 11, and the water outlet 15 is formed in the water guiding base 12. That is, since the water guiding base 12 forms a seal with the cup basket 11 through the inner sealing ring 172, the water guiding base 12 and the bottom of the cup basket 11 also form a chamber 106. The sugar water formed in the sugar dissolving chamber 102 flows into the chamber 106 through the filter mesh 14 and then flows out through the water outlet 15. The opening and closing of the water outlet 15 are controlled by the switch valve 13.

Although the present invention has been specifically shown and described with reference to preferred implementations, those skilled in the art should understand that various changes in form and detail may be made without departing from the spirit and scope of the present invention as defined by the appended claims, and all such changes are within the protection scope of the present invention.

1. A brewing machine with a sugar dissolving function, wherein the brewing machine comprises a brewing chamber, a water guiding cavity, and a sugar dissolving chamber, an outlet of the brewing chamber is connected to the water guiding cavity, the water guiding cavity is arranged on a periphery of the sugar dissolving chamber, a wall of the sugar dissolving chamber is provided with a plurality of circumferentially distributed through holes, the plurality of circumferentially distributed through holes are in communication with the water guiding cavity, a bottom of the sugar dissolving chamber is provided with a water outlet, and the water outlet is provided with a switch valve.

2. The brewing machine with a sugar dissolving function according to claim 1, wherein the plurality of circumferentially distributed through holes provided in the wall of the sugar dissolving chamber comprise a plurality of water passing holes and a plurality of steam holes, and a height of each of the plurality of steam holes is greater than a height of each of the plurality of water passing holes.

3. The brewing machine with a sugar dissolving function according to claim 2, wherein the brewing machine comprises a cup basket part, the cup basket part comprises a cup basket and a water guiding base, the brewing chamber and the sugar dissolving chamber are formed on the cup basket, the water guiding base is sleeved on a peripheral side of the cup basket, the water guiding base and an outer wall of the cup basket jointly form the water guiding cavity, and the plurality of water passing holes and the plurality of steam holes are provided in the outer wall of the cup basket.

4. The brewing machine with a sugar dissolving function according to claim 3, wherein the wall of the sugar dissolving chamber is further provided with air passing holes in communication with the brewing chamber, and a height of each of the air passing holes is greater than a height of the water guiding cavity.

5. The brewing machine with a sugar dissolving function according to claim 2, wherein the brewing chamber is located on one side of the sugar dissolving chamber and above the water guiding cavity, and the wall of the sugar dissolving chamber is not provided with the plurality of water passing holes at a side of the sugar dissolving chamber corresponding to the outlet of the brewing chamber.

6. The brewing machine with a sugar dissolving function according to claim 5, wherein the sugar dissolving chamber is a tapered chamber with a wider top than bottom, and an angle between a tapered side wall of the sugar dissolving chamber and a vertical central axis is less than or equal to 45°.

7. The brewing machine with a sugar dissolving function according to claim 2, wherein a filter mesh is provided at a top of the water outlet, and a height of the filter mesh is less than the height of each of the plurality of water passing holes, a height difference between the plurality of water passing holes and the filter mesh is greater than 5 mm, and a height difference between the plurality of steam holes and the plurality of water passing holes is greater than 10 mm.

8. The brewing machine with a sugar dissolving function according to claim 2, wherein the switch valve comprises a push rod, a silicone ring, and an elastic member, the push rod runs through the water outlet of the sugar dissolving chamber with a gap, the silicone ring is fixed at a first end of the push rod extending into the sugar dissolving chamber, and the elastic member applies an elastic force away from the sugar dissolving chamber to the push rod, so that the silicone ring on the push rod is pressed to seal the water outlet of the sugar dissolving chamber.

9. The brewing machine with a sugar dissolving function according to claim 3, wherein the brewing machine further comprises a housing, a water tank, and a heating assembly, the water tank, the heating assembly, and the cup basket part are all arranged at the housing, an outlet of the water tank is connected to the heating assembly, an output end of the heating assembly is connected to the brewing chamber to output heated water to the brewing chamber, a clearance space for placing a container is formed on one side of the housing, and the water outlet of the sugar dissolving chamber is located at a top of the clearance space.

10. The brewing machine with a sugar dissolving function according to claim 1, wherein the brewing machine comprises a cup basket part, the cup basket part comprises a cup basket and a water guiding base, the brewing chamber and the sugar dissolving chamber are formed on the cup basket, a periphery of the cup basket is integrally connected with an annular wall, thereby forming an annular cavity with a bottom opening, the water guiding base is sealed and fixedly covers the bottom opening of the annular cavity, thereby jointly forming the water guiding cavity, and a plurality of through holes are provided in a side wall of the cup basket.

11. The brewing machine with a sugar dissolving function according to claim 3, wherein the brewing chamber is located on one side of the sugar dissolving chamber and above the water guiding cavity, and the wall of the sugar dissolving chamber is not provided with the plurality of water passing holes at a side of the sugar dissolving chamber corresponding to the outlet of the brewing chamber.

12. The brewing machine with a sugar dissolving function according to claim 2, wherein the brewing machine comprises a cup basket part, the cup basket part comprises a cup basket and a water guiding base, the brewing chamber and the sugar dissolving chamber are formed on the cup basket, a periphery of the cup basket is integrally connected with an annular wall, thereby forming an annular cavity with a bottom opening, the water guiding base is sealed and fixedly covers the bottom opening of the annular cavity, thereby jointly forming the water guiding cavity, and a plurality of through holes are provided in a side wall of the cup basket.
